(19) United States
(12) Patent Application Publication
(10) Pub. No.: US 2026/0370739 A1
(43) Pub. Date: Nov. 19, 2026

(54) METHODS, DEVICES, AND SYSTEMS FOR SUPPORTING PDU SET BASED HANDLING IN DUAL CONNECTIVITY

(71) Applicant: ZTE Corporation, Shenzhen (CN)

(72) Inventors: Yingjun ZHOU, Shenzhen (CN); Zhuang LIU, Shenzhen (CN); Dapeng LI, Shenzhen (CN); Yin GAO, Shenzhen (CN); Xiubin SHA, Shenzhen (CN)

(73) Assignee: ZTE Corporation, Shenzhen (CN)

(21) Appl. No.: 19/733,049

(22) Filed: Jul. 7, 2026

Related U.S. Application Data
(63) Continuation of application No. PCT/CN2024/071202, filed on Jan. 8, 2024.

(51) Int. Cl. H04L 69/322; H04W 36/00

(52) U.S. Cl. CPC H04L 69/322; H04W 36/0069

(57) ABSTRACT

The present disclosure describes methods, system, and devices for supporting protocol data unit (PDU) set based handling in dual connectivity (DC). One method includes determining, by a first network node, a first indicator set for sending to a core network (CN) based on supportability for PDU set based handling by at least one of two network nodes configured in a DC, wherein the two network nodes comprise the first network node and a second network node. Another method includes receiving, by a CN from a first network node, a first indicator set determined by the first network node based on supportability for PDU set based handling by at least one of two network nodes configured in a DC, wherein the two network nodes comprise the first network node and a second network node.

### TECHNICAL FIELD

The present disclosure is directed generally to wireless communications. Particularly, the present disclosure relates to methods, devices, and systems for supporting protocol data unit (PDU) set based handling in dual connectivity (DC).

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

In some implementations, protocol data unit (PDU) set based

handling may be supported, wherein a set of PDUs may be handled as a set rather than as individually separated PDUs. There are some issues/problems associated with supporting PDU set based handling in dual connectivity (DC). For example, in DC, a master node (MN) may not know whether a corresponding secondary node (SN) supports the PDU set based handling, and thus, the MN may not know whether to send the PDU set based handling indicator to a core network (CN).

The present disclosure describes various embodiments for supporting PDU set based handling in DC, addressing at least one of the issues/problems discussed above, enhancing the coordination among a plurality of network nodes to achieve flexible activation and deactivation of PDU set identification and marking, which improves the efficiency and/or performance of the wireless communication. Various embodiments in the present disclosure may achieve low latency, low overhead, and short interruption time, thus, improving the efficiency and/or performance of the wireless communication.

### SUMMARY

This document relates to methods, systems, and devices for wireless communication, and more specifically, for supporting protocol data unit (PDU) set based handling in dual connectivity (DC). Various embodiments in the present disclosure may increase the resource utilization efficiency, boost latency performance of the wireless communication, and/or conserve energy consumption of user equipment.

In one embodiment, the present disclosure describes a method for wireless communication. The method includes determining, by a first network node, a first indicator set for sending to a core network (CN) based on supportability for protocol data unit (PDU) set based handling by at least one of two network nodes configured in a dual connectivity (DC), wherein the two network nodes comprise the first network node and a second network node.

In another embodiment, the present disclosure describes a method for wireless communication. The method includes receiving, by a CN from a first network node, a first indicator set determined by the first network node based on supportability for PDU set based handling by at least one of two network nodes configured in a DC, wherein the two network nodes comprise the first network node and a second network node.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods. The computer-readable medium may include a non-transitory computer-readable medium.

The above and other aspects and their implementations are described in greater detail in the drawings, the descriptions, and the claims.

### BRIEF DESCRIPTION OF THE DRAWINGS

FIG. 1A shows a schematic diagram of a wireless communication system.

FIG. 1B shows a schematic diagram of a base station.

FIG. 2 shows an example of a network node.

FIG. 3 shows an example of a user equipment.

FIG. 4A shows a flow diagram of a method for wireless communication.

FIG. 4B shows a flow diagram of another method for wireless communication.

FIG. 5 shows a flow diagram of an exemplary embodiment for wireless communication.

FIG. 6 shows a flow diagram of another exemplary embodiment for wireless communication.

FIG. 7 shows a flow diagram of another exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes various embodiments for supporting protocol data unit (PDU) set based handling in dual connectivity (DC).

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

Some devices and applications require high date rate and low latency, for example, applications including multi-modal services, such as Extended Reality (XR), Virtual Reality (VR), Mixed Reality (MR), metaverse, video streaming. To support multi-modal services, protocol data unit (PDU) set based handling needs to be performed to ensure user experience. There are some issues/problems associated with supporting PDU set based handling in DC. For one example, in DC, a master node (MN) may not know whether a corresponding secondary node (SN) supports the PDU set based handling, and thus, the MN may not know whether to send the PDU set based handling indicator to a core network (CN).

The present disclosure describes various embodiments for supporting PDU set based handling in DC, addressing at least one of the issues/problems discussed above, enhancing the coordination among a plurality of network nodes to achieve flexible activation and deactivation of PDU set identification and marking, which improves the efficiency and/or performance of the wireless communication. Various embodiments in the present disclosure may achieve low latency, low overhead, and short interruption time, thus, improving the efficiency and/or performance of the wireless communication.

Various embodiments in the present disclosure may include methods for informing a MN whether a SN supports the PDU set based handling and/or for deciding whether to send a PDU set based handling indicator to the CN.

In some implementations, DC may refer to a case where a multiple receiving/transmitting (Rx/Tx) capable UE may be configured to utilise resources provided by two different nodes connected via non-ideal backhaul. One node acts as the MN and the other as the SN. The MN and SN are connected via a network interface and at least the MN is connected to the core network. In some implementations, the MN and/or the SN can be operated with shared spectrum channel access.

In some implementations, DC is designed based on the assumption of non-ideal backhaul between the different nodes but can also be used in case of ideal backhaul.

In some implementations, some DC operations are for aggregated node cases; and some DC operations are for non-aggregated node case.

In some implementations, MN terminated bearer may refer to, in DC, a radio bearer for which PDCP is located in the MN; master cell group (MCG) may refer to, in DC, a group of serving cells associated with the Master Node, comprising of the SpCell (PCell) and optionally one or more SCells; MCG bearer may refer to, in DC, a radio bearer with an RLC bearer (or two RLC bearers, in case of CA packet duplication in an E-UTRAN cell group, or up to four RLC bearers in case of CA packet duplication in a NR cell group) only in the MCG; secondary cell group (SCG) may refer to, in DC, a group of serving cells associated with the Secondary Node, comprising of the SpCell (PSCell) and optionally one or more SCells; secondary node (SN) may refer to, in DC, the radio access node, with no control plane connection to the core network, providing additional resources to the UE. It may be an en-gNB (in EN-DC), a Secondary ng-eNB (in NE-DC) or a Secondary gNB (in NR-DC and NGEN-DC); SCG bearer may refer to, in DC, a radio bearer with an RLC bearer (or two RLC bearers, in case of CA packet duplication in an E-UTRAN cell group, or up to four RLC bearers in case of CA packet duplication in a NR cell group) only in the SCG; SN terminated bearer may refer to, in DC, a radio bearer for which PDCP is located in the SN; SpCell may refer to primary cell of a master or secondary cell group; split bearer may refer to, in DC, a radio bearer with RLC bearers both in MCG and SCG; and/or split PDU Session (or PDU session split) may refer to a PDU Session whose QoS Flows are served by more than one SDAP entities in the NG-RAN.

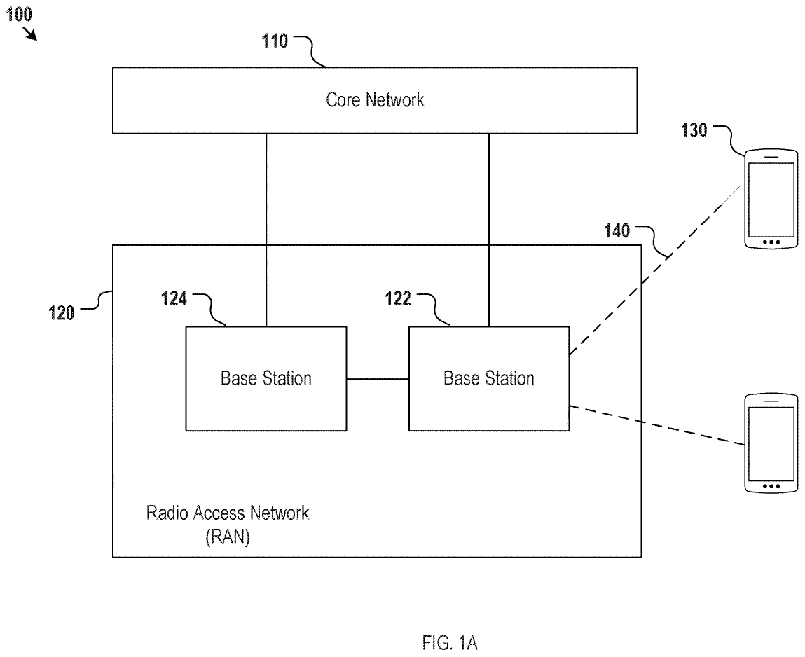

FIG. 1A shows an example of cellular wireless communication network 100 (also referred to as wireless communication system) that includes a core network 110, a radio access network (RAN) 120, and one or more user equipment (UE) 130. The RAN 120 further includes multiple base stations 122 and 124 (or referred as network nodes or RANs). The base station 122 and one or more user equipment (UE) 130 communicate with one another via Uu interface 140. The wireless communication network 100 may be implemented as, as for example, a 2G, 3G, 4G/LTE, 5G, or 6G cellular communication network. Correspondingly, each of the RANs/base stations 122 and 124 may be implemented as a 2G RAN/base station, a 3G RAN/nodeB, an LTE RAN/eNB, a 5G New Radio (NR) RAN/gNB, and/or a NG RAN. The UE 130 may be implemented as mobile or fixed communication devices for accessing the wireless communication network 100. The one or more UE 130 may include but is not limited to mobile phones, internet of things (IoT) devices, machine-type communications (MTC) devices, laptop computers, tablets, personal digital assistants, wearable devices, distributed remote sensor devices, roadside assistant equipment, and desktop computers. Alternative to the context of cellular wireless network, the RAN 120 and the principles described below may be implemented as other types of radio access networks, such as Wi-Fi, Bluetooth, ZigBee, and WiMax networks.

In the example wireless communication system 100 of FIG. 1A, the one or more UE 130 may connect with and establish a communication session with the base station 122 via the Uu interface 140. The communication session between the UE 130 and the base station 122 may utilize downlink (DL) and/or uplink (UL) transmission resources. The DL transmission resource carries data from the base station 122 to the UE 130, and the UL transmission resource carries data from the UE 130 to the base station 122. Under certain circumstances, for example when the base station 122 is unavailable or when the UE 130 moves into a coverage of the base station 124, the one or more UE 130 may connect with and establish a communication session with the base station 122, for example, during a handover process.

Referring to FIG. 1B, a RAN/base station (e.g., gNB) (using 122 as non-limiting example) may have a control-distributed separated structure, which may include a control unit (CU) 160 and one or more distributed unit (DU) 171 and/or 172. The 5GC may communicate with the gNB via a NG interface between them. The gNB and another gNB may communicate via a Xn-C interface. The gNB-CU may communicate with the one or more gNB-DU via a F1 interface.

In some implementations, in the architecture of CU/DU split, a gNB may consist of a gNB Central Unit (gNB-CU) and one or more gNB Distributed Unit (gNB-DU). A gNB-CU and a gNB-DU is connected via F1 interface. The gNB-CU is defined as a logical node hosting RRC, SDAP and PDCP protocols of the gNB or RRC and PDCP protocols of the en-gNB that controls the operation of one or more gNB-DUs. The gNB-DU is defined as a logical node hosting RLC, MAC and PHY layers of the gNB or en-gNB, and its operation is partly controlled by gNB-CU. One gNB-DU supports one or multiple cells. One cell is supported by only one gNB-DU.

In some implementations, the gNB-CU is defined as a logical node hosting RRC, SDAP and PDCP protocols of the gNB or RRC and PDCP protocols of the en-gNB that controls the operation of one or more gNB-DUs. The gNB-DU is defined as a logical node hosting RLC, MAC and PHY layers of the gNB or en-gNB, and its operation is partly controlled by gNB-CU. One gNB-DU supports one or multiple cells. One cell may be supported by only one gNB-DU.

In various embodiments/implementations in the present disclosure, a protocol data unit (PDU) set may be a set including one or more PDUs carrying the payload of one unit of information generated at the application level (e.g. a frame or video slice for XRM services). In some implementations, all PDUs in a PDU set are needed by the application layer to use the corresponding unit of information; and in other implementations, the application layer can still recover parts all or of the information unit, when some PDUs are missing.

In various embodiments/implementations in the present disclosure, a PDU may refer to a NR-U PDU or PDCP PDU contained in NR-U PDU, wherein the NR-U PDU may refer to a Xn-U PDU or F1-U PDU. In various embodiments/implementations in the present disclosure, a PDU may refer to a NG-U PDU or PDCP PDU contained in the NG-U PDU. In some implementations, a core network may send NG-U PDU (also GTP-U PDU) to the base station. The data packets inside are IP packets. A protocol may modify the GTP-U extension header, the base station (e.g., CU) may extract the data packet after getting the PDU of the core network, encapsulate it into a PDCP PDU, and add a GTP-U extension header to it (encapsulated into a GTP-U PDU, also NR-U PDU), plus PDCP header to a DU. In various implementations, a NR PDCP PDU may refer to a PDCP PDU; and/or a PDCP PDU may include a NR PDCP PDU.

In some implementations with non-homogenous support of PDU set based handling in a NG-RAN, by sending at least one PDU set QoS parameter to the NG-RAN, a session management function (SMF) requests the NG-RAN to activate PDU set QoS handling for a given QoS flow and the NG-RAN provides the SMF with an indication of whether the PDU set based handling is supported. Based on this, the SMF may activate the PDU set identification and marking in the PDU session anchor (PSA) user plane function (UPF).

In some implementations, at NG-RAN Xn handover and N2 handover, a target NG-RAN provides to the SMF with an indication of whether the target NG-RAN node supports PDU set based handling. Based on the NG-RAN indication, the SMF may, upon completion of the handover procedure, initiate the PDU session modification procedure to provide PDU set QoS parameters to the NG-RAN and configure the PSA UPF to activate/deactivate the PDU set identification and marking.

In some implementations where the PSA UPF identifies and marks PDUs with PDU set information in GTP-U header, it may start doing so from a complete PDU Set.

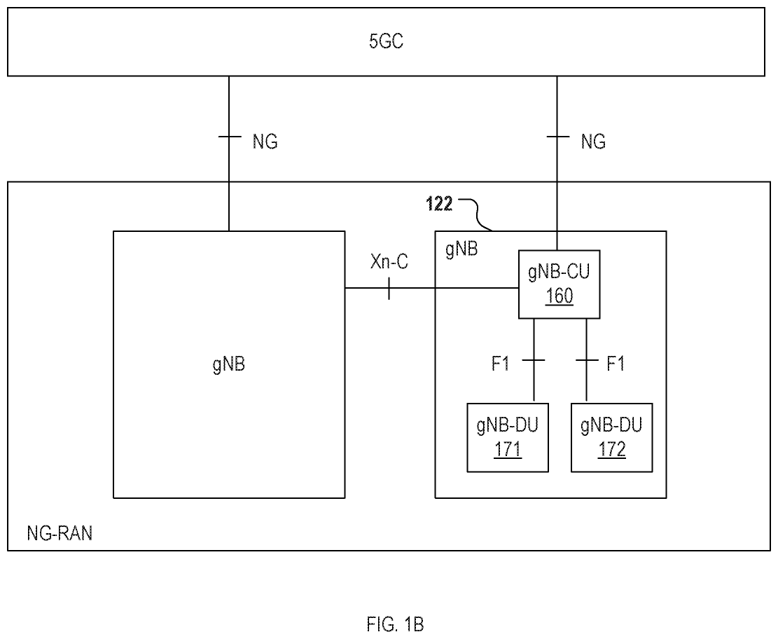

FIG. 2 shows an example of electronic device 200 to implement a network base station (wireless communication node or gNB) or core network. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

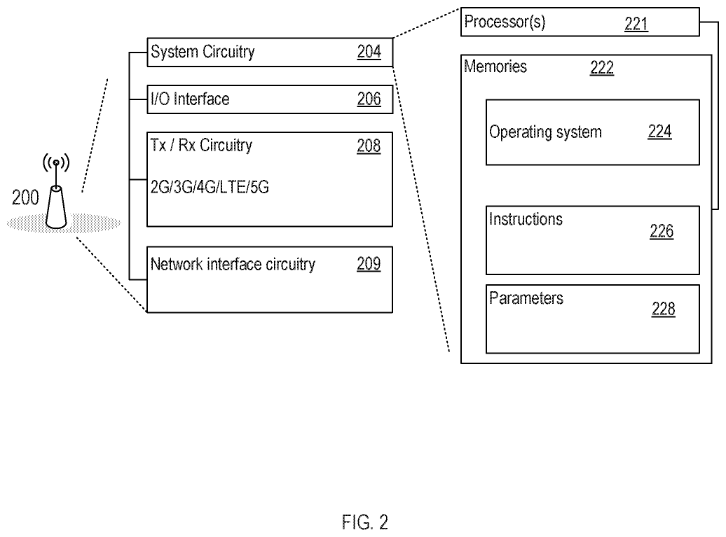

FIG. 3 shows an example of an electronic device to implement a terminal device 300 (for example, wireless communication terminal or user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for supporting PDU set based handling in DC, which may be implemented, partly or totally, on the core network, the network base station, and/or the user equipment described above in FIGS. 1A to 3.

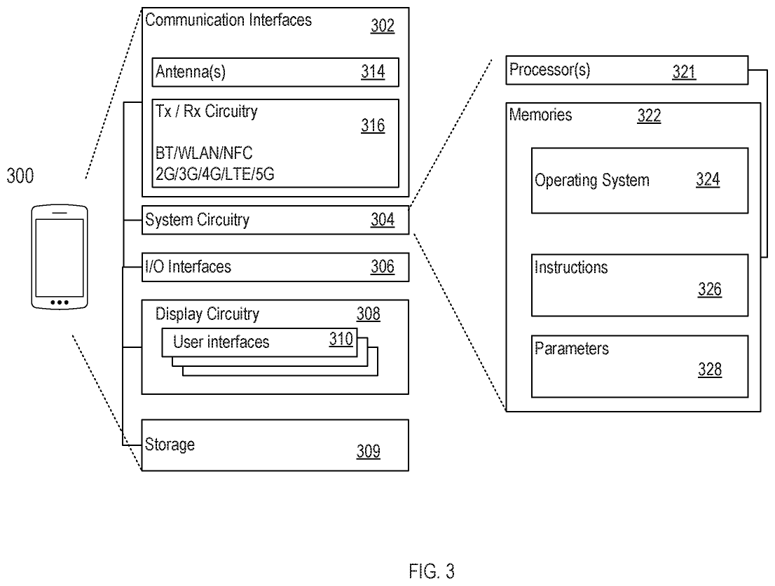

Referring to FIG. 4A, the present disclosure describes various embodiments of a method 400 for wireless communication. The method 400 may include step 402, determining, by a first network node, a first indicator set for sending to a core network (CN) based on supportability for protocol data unit (PDU) set based handling by at least one of two network nodes configured in a dual connectivity (DC), wherein the two network nodes comprise the first network node and a second network node.

Referring to FIG. 4B, the present disclosure describes various embodiments of a method 420 for wireless communication. The method 420 may step 422, receiving, by a CN from a first network node, a first indicator set determined by the first network node based on supportability for PDU set based handling by at least one of two network nodes configured in a DC, wherein the two network nodes comprise the first network node and a second network node.

In some implementations, in addition to a portion, an entire, or any combination of the described implementation(s)/embodiment(s), the first network node comprises a master node (MN) in the DC, and the second network node comprises a secondary node (SN) in the DC.

In some implementations, in addition to a portion, an entire, or any combination of the described implementation(s)/embodiment(s), before the first network node determines the first indicator set: in response to the second network node supporting PDU set based handling, the second network node sends, to the first network node, a first message comprising a second indicator, wherein the second indicator indicates whether the second network node supports the PDU set based handling.

In some implementations, in addition to a portion, an entire, or any combination of the described implementation(s)/embodiment(s), before the first network node determines the first indicator set: the first network node receives a second message from a core network (CN), the second message comprising at least one set of PDU set parameters for at least one quality-of-service (QoS) flow; and/or the first network node sends a third message to the second network node, the third message comprising the at least one set of PDU set parameters for the at least one QoS flow.

In some implementations, in addition to a portion, an entire, or any combination of the described implementation(s)/embodiment(s), after the first network node determines the first indicator set: the first network node sends a fourth message to the CN, the fourth message comprising the first indicator set; and/or based on the received first indicator set, the CN activates or deactivates PDU set identification and marking.

In some implementations, in addition to a portion, an entire, or any combination of the described implementation(s)/embodiment(s), the first message comprises a first Xn interface message comprising one of the following: a SN addition request acknowledge message, or a SN modification request acknowledge message; the second message comprises a first NG interface message comprising one of the following: a PDU session resource setup request message, or a PDU session resource modify request message; the third message comprises a second Xn interface message comprising one of the following: a SN addition request message, or a SN modification request message; and/or the fourth message comprises a second NG interface message comprising one of the following: a PDU session resource setup response message, or a PDU session resource modify response message.

In some implementations, in addition to a portion, an entire, or any combination of the described implementation(s)/embodiment(s), the first indicator set comprises a single first indicator; and/or the first indicator indicates whether a radio access network (RAN) supports PDU set based handling.

In some implementations, in addition to a portion, an entire, or any combination of the described implementation(s)/embodiment(s), when the PDU session is a split PDU session, the first network node determining the first indicator set comprises: in response to at least one of the first network node and the second network node not supporting the PDU set based handling, the first network node determines the single first indicator as not support, and/or in response to both of the first network node and the second network node supporting the PDU set based handling, the first network node determines the single first indicator as support.

In some implementations, in addition to a portion, an entire, or any combination of the described implementation(s)/embodiment(s), the first indicator set comprises a pair of first indicators; and/or the pair of first indicators indicates whether each of the first network node and the second network node supports PDU set based handling.

In some implementations, in addition to a portion, an entire, or any combination of the described implementation(s)/embodiment(s), when the PDU session is a split PDU session, the first network node determining the first indicator set comprises: the first network node determines one indicator of the pair of the first indicators based on whether the first network node supports the PDU set based handling, and/or the first network node determines another indicator of the pair of the first indicators based on whether the second network node supports the PDU set based handling.

In some implementations, in addition to a portion, an entire, or any combination of the described implementation(s)/embodiment(s), the first indicator set comprises a single first indicator; the network resources of the second network node are used; and/or the first indicator indicates whether a radio access network (RAN) supports PDU set based handling.

In some implementations, in addition to a portion, an entire, or any combination of the described implementation(s)/embodiment(s), the first network node determining the first indicator set comprises: in response to the first network node receiving the second indicator from the second network node and the first network node not allocating network resources of the first network node, the first network node determines the single first indicator based on whether only the second network node supports the PDU set based handling; and/or in response to the first network node receiving the second indicator from the second network node and the first network node allocating network resources of the first network node, the first network node determines the single first indicator based on whether both of the first network node and the second network node support the PDU set based handling.

In some implementations, in addition to a portion, an entire, or any combination of the described implementation(s)/embodiment(s), the first network node determines whether to send the first indicator set to the CN based on whether a PDU set based handling support status changes at any one of the two network nodes.

In some implementations, in addition to a portion, an entire, or any combination of the described implementation(s)/embodiment(s), before the first network node determines the first indicator set: in response to the second network node changing its support status of PDU set based handling, the second network node sends, to the first network node, a first message comprising a second indicator, wherein the second indicator indicates whether the second network node supports the PDU set based handling; and/or upon receiving the first message, the first network node sends a fifth message to the second network node.

In some implementations, in addition to a portion, an entire, or any combination of the described implementation(s)/embodiment(s), the first message comprises a first Xn interface message comprising one of the following: a SN modification required message, or a SN change required message; and/or the fifth message comprises a second Xn interface message comprising one of the following: a SN modification confirm message, or a SN change confirm message.

In some implementations, in addition to a portion, an entire, or any combination of the described implementation(s)/embodiment(s), the first indicator set comprises a single first indicator; the first indicator indicates whether a radio access network (RAN) supports PDU set based handling; and/or when the PDU session is a split PDU session, the first network node determining the first indicator set comprises: in response to at least one of the first network node and the second network node not supporting the PDU set based handling, the first network node determines the single first indicator as not support, and/or in response to both of the first network node and the second network node supporting the PDU set based handling, the first network node determines the single first indicator as support.

In some implementations, in addition to a portion, an entire, or any combination of the described implementation(s)/embodiment(s), the first indicator set comprises a pair of first indicators; the pair of first indicators indicates whether each of the first network node and the second network node supports PDU set based handling; and/or when the PDU session is a split PDU session, the first network node determining the first indicator set comprises: the first network node determines one indicator of the pair of the first indicators based on whether the first network node supports the PDU set based handling, and/or the first network node determines another indicator of the pair of the first indicators based on whether the second network node supports the PDU set based handling.

In some implementations, in addition to a portion, an entire, or any combination of the described implementation(s)/embodiment(s), the first indicator set comprises a single first indicator; the network resources of the second network node are used; the first indicator indicates whether a radio access network (RAN) supports PDU set based handling; and/or the first network node determining the first indicator set comprises: in response to the first network node receiving the second indicator from the second network node and the first network node not allocating network resources of the first network node, the first network node determines the single first indicator based on whether only the second network node supports the PDU set based handling; and/or in response to the first network node receiving the second indicator from the second network node and the first network node allocating network resources of the first network node, the first network node determines the single first indicator based on whether both of the first network node and the second network node support the PDU set based handling.

In some implementations, in addition to a portion, an entire, or any combination of the described implementation(s)/embodiment(s), after the first network node determines the first indicator set: the first network node sends a sixth message to the CN, the sixth message comprising the first indicator set; and/or based on the received first indicator set, the CN activates or deactivates PDU set identification and marking.

In some implementations, in addition to a portion, an entire, or any combination of the described implementation(s)/embodiment(s), the CN responds with a seventh message to the first network node.

In some implementations, in addition to a portion, an entire, or any combination of the described implementation(s)/embodiment(s), the sixth message comprises a first NG interface message comprising a PDU session resource modify indication message, or a PDU session resource notify message; and/or the seventh message comprises a second NG interface message comprising a PDU session resource modify confirm message.

In some implementations, in addition to a portion, an entire, or any combination of the described implementation(s)/embodiment(s), the supportability for PDU set based handling comprises at least one of the following: to support the PDU set based handling for a PDU session, to support the PDU set based handling for a UE, or to support the PDU set based handling for a QoS flow.

The present disclosure describes various embodiments with exemplary examples for supporting PDU set based handling in DC. Exemplary embodiments provide examples for the present disclosure, and does not impose any limitation on the present disclosure. In the embodiments and implementation of this disclosure, any steps and/or operations may be combined or arranged in any amount or order, as desired. Two or more of the steps and/or operations may be performed in parallel. Embodiments and implementations in the disclosure may be used separately or combined in any order. Further, any one of the methods (or embodiments), a wireless communication node, and a wireless communication device may be implemented by processing circuitry (e.g., one or more processors or one or more integrated circuits).

In various embodiments, the PDU may refer to a NG-U PDU, NR-U PDU or NR PDCP PDU contained in NR-U PDU.

In various embodiments, when a device (e.g., a communication node, a MN, a SN, etc.) supports PDU set based handling, the device may support PDU set based handling at any or all of four levels, i.e. PDU session level, UE level, QoS flow level, and/or gNB level; and in other words, to support the PDU set based handling comprises to support the PDU set based handling for a PDU session, to support the PDU set based handling for a UE, to support the PDU set based handling for a QoS flow, and/or to support the PDU set based handling for a gNB.

### Embodiment Set I

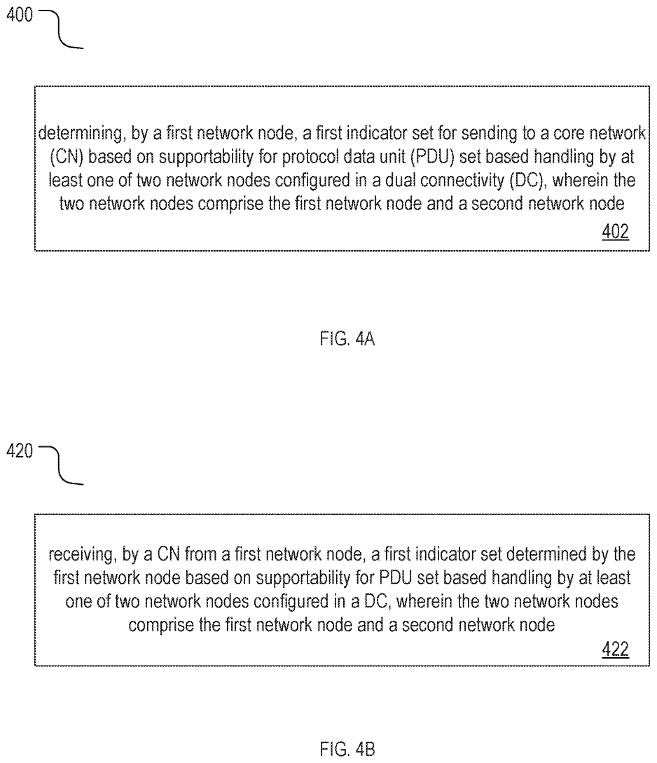

In various embodiments, as shown in FIG. 5, a first network node may be a master node (MN) 590 in a DC, and a second network node may be a secondary node (SN) 592 in the DC. The method may include a portion or all of the following steps.

For step 510, the MN may send a PDU set based handling request indicator to the SN via a message (Xn interface message, e.g. an Xn setup request message, a NG-RAN node configuration update message, a SN addition request message, or any other message) to request the SN respond whether the SN supports PDU set based handling.

For step 520, when the SN supports PDU set based handling, it may send a PDU set based handling indicator to the MN via a message (Xn interface message, e.g. an Xn setup response message, a NG-RAN node configuration update acknowledge message, a SN addition request acknowledge message, or any other message).

The PDU set based handling indicator is used to notify that the MN that whether the SN supports PDU set based handling.

In some implementations, the PDU set based handling indicator is used to notify the MN that the SN supports the PDU set based handling. Therefore, the inclusion of the PDU set based handling indicator indicates that the SN supports the PDU set based handling; and the non-inclusion of the PDU set based handling indicator indicates that the SN does not support the PDU set based handling. In some implementations, the PDU set based handling indicator may be used to notify that the SN supports PDU set based handling for all the UEs or all the PDU sessions or all the QoS flows.

In some implementations, the PDU set based handling indicator is used to notify the MN that the SN supports the PDU set based handling for a certain PDU session or for a certain UE or for a certain QoS flow. Therefore, the inclusion of the PDU set based handling indicator indicates that the SN supports the PDU set based handling for the certain PDU session or for the certain UE or for the certain QoS flow; and the non-inclusion of the PDU set based handling indicator indicates that the SN does not support the PDU set based handling for the certain PDU session or for the certain UE or for the certain QoS flow.

In some implementations, the PDU set based handling indicator is used to notify the MN whether the SN supports the PDU set based handling. For example, a first value (e.g., “0”) of the PDU set based handling indicator indicates that the SN does not support the PDU set based handling; and a second value (e.g., “1”) of the PDU set based handling indicator indicates that the SN supports the PDU set based handling. Vice versa, the first value may be “1” and the second value may be “0”. For another example, a first value (e.g., “not support”) of the PDU set based handling indicator indicates that the SN does not support the PDU set based handling; and a second value (e.g., “support”) of the PDU set based handling indicator indicates that the SN supports the PDU set based handling. In some implementations, the PDU set based handling indicator may be used to notify whether the SN supports PDU set based handling for all the UEs or all the PDU sessions or all the QoS flows.

In some implementations, the PDU set based handling indicator is used to notify the MN whether the SN supports the PDU set based handling for a certain PDU session or for a certain UE or for a certain QoS flow. For example, a first value (e.g., “0”) of the PDU set based handling indicator indicates that the SN does not support the PDU set based handling for the certain PDU session or for the certain UE or for the certain QoS flow; and a second value (e.g., “1”) of the PDU set based handling indicator indicates that the SN supports the PDU set based handling for the certain PDU session or for the certain UE or for the certain QoS flow. Vice versa, the first value may be “1” and the second value may be “0”. For another example, a first value (e.g., “not support”) of the PDU set based handling indicator indicates that the SN does not support the PDU set based handling for the certain PDU session or for the certain UE or for the certain QoS flow; and a second value (e.g., “support”) of the PDU set based handling indicator indicates that the SN supports the PDU set based handling for the certain PDU session or for the certain UE or for the certain QoS flow.

### Embodiment Set II

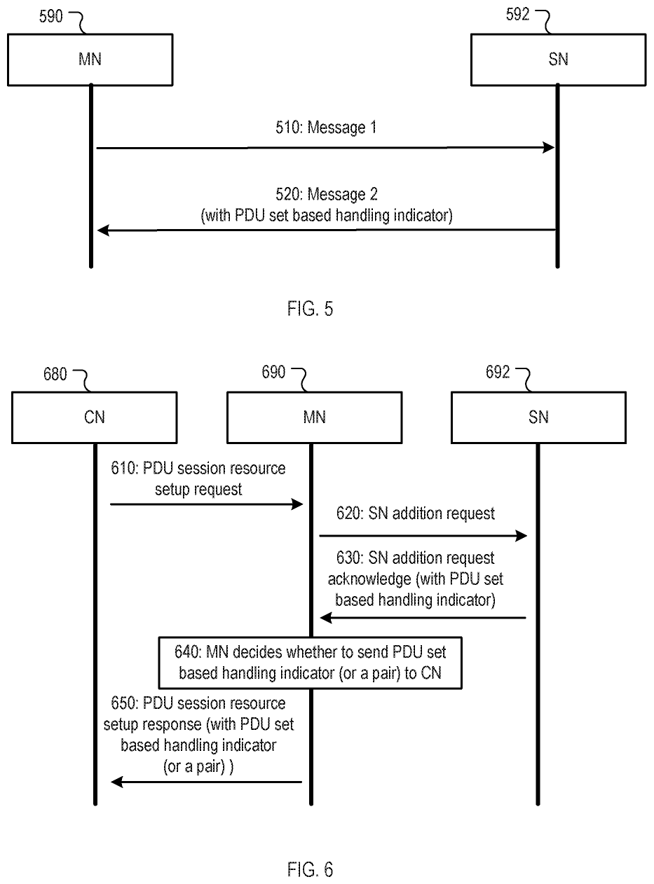

In various embodiments, as shown in FIG. 6, a first network node may be a master node (MN) 690 in a DC, and a second network node may be a secondary node (SN) 692 in the DC, wherein the MN communicates with a core network (CN) 680. The method may include a portion or all of the following steps.

For step 610, the CN sends at least one set of PDU set parameters for at least one QoS flow to the MN via a message (a NG interface message, e.g. a PDU session resource setup request message, a PDU session resource modify request message, or any other message).

### For Step 620, the Mn Sends the at Least One Set of Pdu Set

parameters for the at least one QoS flow to the SN via a message (a Xn interface message, e.g. a SN addition request message, a SN modification request message, or any other message).

For step 630, when the SN supports PDU set based handling for a certain PDU session or for a certain UE or for a certain QoS flow, it sends at least one PDU set based handling indicator for the certain PDU session or for the certain UE or for the certain QoS flow to the MN via a message (Xn interface message, e.g. a SN addition request acknowledge message, a SN modification request acknowledge message, or any other message).

Similar to the PDU set based handling indicator in step 520, the inclusion or non-inclusion of the PDU set based handling indicator may be used to notify the MN whether the SN supports the PDU set based handling for a certain PDU session or for a certain UE or for a certain QoS flow; and/or different values of the PDU set based handling indicator may be used to indicate whether the SN supports the PDU set based handling for a certain PDU session or for a certain UE or for a certain QoS flow.

For step 640, the MN decides whether to send at least one PDU set based handling indicator for the certain PDU session or for the certain UE or for the certain QoS flow to the CN based on whether the MN and/or the SN supports PDU set based handling for the certain PDU session or for the certain UE or for the certain QoS flow.

Similar to the PDU set based handling indicator in step 520, the inclusion or non-inclusion of the PDU set based handling indicator may be used to notify whether the RAN supports the PDU set based handling for a certain PDU session or for a certain UE or for a certain QoS flow; and/or different values of the PDU set based handling indicator may be used to indicate whether the RAN supports the PDU set based handling for a certain PDU session or for a certain UE or for a certain QoS flow.

For example, for a split PDU session, the MN may send at least one PDU set based handling indicator with the value “not support” to the CN for the certain PDU session or for the certain UE or for the certain QoS flow when one of the MN or SN does not support PDU set based handling for the certain PDU session or for the certain UE or for the certain QoS flow.

For example, for a split PDU session, the MN may send at least one PDU set based handling indicator with the value “support” to the CN for the certain PDU session or for the certain UE or for the certain QoS flow when both the MN and the SN support PDU set based handling for the certain PDU session or for the certain UE or for the certain QoS flow.

For step 650, when the MN decides to send at least one PDU set based handling indicator for the certain PDU session or for the certain UE or for the certain QoS flow to the CN, the MN sends at least one PDU set based handling indicator for the certain PDU session or for the certain UE or for the certain QoS flow to the CN via a message (NG interface message, e.g. a PDU session resource setup response message, a PDU session resource modify response message, or any other message).

Similar to the PDU set based handling indicator in step 520, the inclusion or non-inclusion of the PDU set based handling indicator may be used to notify the CN whether the RAN supports the PDU set based handling for a certain PDU session or for a certain UE or for a certain QoS flow; and/or different values of the PDU set based handling indicator may be used to indicate whether the RAN supports the PDU set based handling for a certain PDU session or for a certain UE or for a certain QoS flow.

Based on the PDU set based handling indicator, the CN may activate or deactivate the PDU set identification and marking.

### Embodiment Set III

In various embodiments, as shown in FIG. 6, the method may include a portion or all of the following steps.

Steps 610, 620, and 630 may be the same as the corresponding steps in Embodiment set II.

For Step 640, the MN decides whether to send at least one pair of PDU set based handling indicator for the certain PDU session or for the certain UE or for the certain QoS flow to the CN based on whether the MN and/or the SN supports PDU set based handling for a certain PDU session or for the UE.

For example, for a split PDU session, the MN may send at least one pair of PDU set based handling indicators to the CN. One of a pair of PDU set based handling indicator indicates whether the MN supports PDU set based handling for the certain PDU session or for the certain UE or for the certain QoS flow. The other one of a pair of PDU set based handling indicator indicates whether the SN supports PDU set based handling for the certain PDU session or for the certain UE or for the certain QoS flow.

Similar to the PDU set based handling indicator in step 520, the inclusion or non-inclusion of any one of the pair of PDU set based handling indicator may be used to notify whether the SN or MN supports the PDU set based handling for a certain PDU session or for a certain UE or for a certain QoS flow; and/or different values of any one of the pair of PDU set based handling indicator may be used to indicate whether the SN or MN supports the PDU set based handling for a certain PDU session or for a certain UE or for a certain QoS flow.

For step 650, when the MN decides whether to send at least one pair of PDU set based handling indicator for the certain PDU session or for the certain UE or for the certain QoS flow, the MN sends at least one pair of PDU set based handling indicator for the certain PDU session or for the certain UE or for the certain QoS flow to the CN via a message (NG interface message, e.g. a PDU session resource setup response message, a PDU session resource modify response message, or any other message).

Similar to the PDU set based handling indicator in step 520, the inclusion or non-inclusion of any one of the pair of PDU set based handling indicator may be used to notify the CN whether the SN or MN supports the PDU set based handling for a certain PDU session or for a certain UE or for a certain QoS flow; and/or different values of any one of the pair of PDU set based handling indicator may be used to indicate whether the SN or MN supports the PDU set based handling for a certain PDU session or for a certain UE or for a certain QoS flow.

Based on the at least one pair of PDU set based handling indicator, the CN may activate or deactivate the PDU set identification and marking.

### Embodiment Set IV

In various embodiments, as shown in FIG. 6, the method may include a portion or all of the following steps.

Steps 610 and 620 may be the same as the corresponding steps in Embodiment set II.

For step 630, for a certain PDU session or a certain UE or a certain QoS flow which uses SN resources, e.g. SN terminated SCG bearers, SN terminated split bearers, or MN terminated SCG bearers, the SN needs to respond whether PDU set based handling is supported or not for the certain PDU session or for the certain UE or for the certain QoS flow by sending at least one PDU set based handling indicator for the certain PDU session or the certain UE or the certain QoS flow to the MN via a message (Xn interface message, e.g. a SN addition request acknowledge message, a SN modification request acknowledge message, or any other message).

Similar to the PDU set based handling indicator in step 520, the inclusion or non-inclusion of the PDU set based handling indicator may be used to notify the MN whether the SN supports the PDU set based handling for a certain PDU session or for a certain UE or for a certain QoS flow; and/or different values of the PDU set based handling indicator may be used to indicate whether the SN supports the PDU set based handling for a certain PDU session or for a certain UE or for a certain QoS flow.

For step 640, the MN decides whether to send at least one PDU set based handling indicator for the certain PDU session or for the certain UE or for the certain QoS flow to the CN based on whether the MN and/or the SN supports PDU set based handling for the certain PDU session or for the certain UE or for the certain QoS flow.

In some implementations, the certain PDU session or the certain UE or the certain QoS flow uses network resources of the SN.

When the MN receives at least one PDU set based handling indicator for the certain PDU session or for the certain UE or for the certain QoS flow from the SN, and when the MN does not allocate MN resources for the certain PDU session or for the certain UE or for the certain QoS flow, the MN may send at least one PDU set based handling indicator for the certain PDU session or for the certain UE or for the certain QoS flow to the CN based on whether the SN supports PDU set based handling for the certain PDU session or for the certain UE or for the certain QoS flow.

When the MN receives at least one PDU set based handling indicator for the certain PDU session or for the certain UE or for the certain QoS flow from the SN, and if the MN allocates MN resources for the certain PDU session or for the certain UE or for the certain QoS flow, the MN may send at least one PDU set based handling indicator for the certain PDU session or for the certain UE or for the certain QoS flow to the CN based on whether the MN and the SN supports PDU set based handling for the certain PDU session or for the certain UE or for the certain QoS flow.

Similar to the PDU set based handling indicator in step 520, the inclusion or non-inclusion of the PDU set based handling indicator may be used to notify whether the RAN supports the PDU set based handling for a certain PDU session or for a certain UE or for a certain QoS flow; and/or different values of the PDU set based handling indicator may be used to indicate whether the RAN supports the PDU set based handling for a certain PDU session or for a certain UE or for a certain QoS flow.

Step 650, when the MN decides to send at least one PDU set based handling indicator for the certain PDU session or for the certain UE or for the certain QoS flow to the CN, the MN sends at least one PDU set based handling indicator for the certain PDU session or for the certain UE or for the certain QoS flow to the CN via a message (NG interface message, e.g. a PDU session resource setup response message, a PDU session resource modify response message, or any other message).

Similar to the PDU set based handling indicator in step 520, the inclusion or non-inclusion of the PDU set based handling indicator may be used to notify the CN whether the RAN supports the PDU set based handling for a certain PDU session or for a certain UE or for a certain QoS flow; and/or different values of the PDU set based handling indicator may be used to indicate whether the RAN supports the PDU set based handling for a certain PDU session or for a certain UE or for a certain QoS flow.

Based on the at least one PDU set based handling indicator, the CN may activate or deactivate the PDU set identification and marking.

### Embodiment Set V

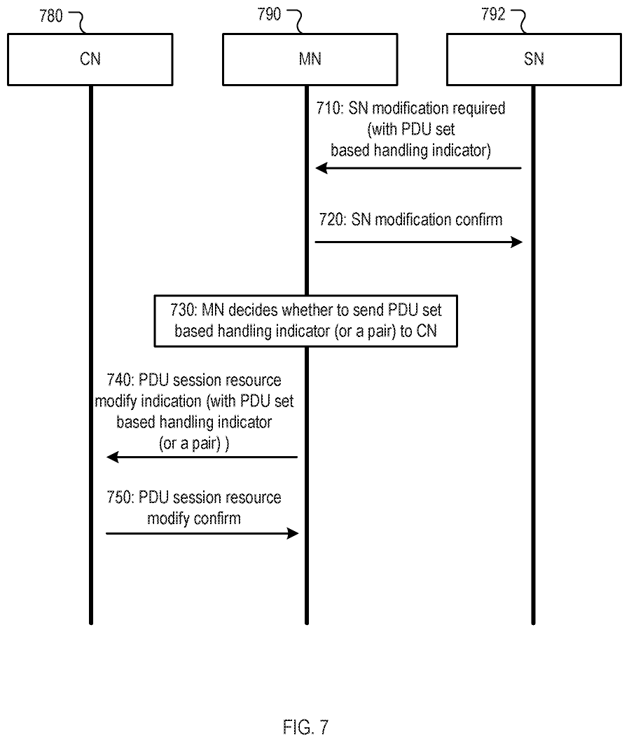

In various embodiments, as shown in FIG. 7, a first network node may be a master node (MN) 790 in a DC, and a second network node may be a secondary node (SN) 792 in the DC, wherein the MN communicates with a core network (CN) 780. The method may include a portion or all of the following steps.

For step 710, for a certain PDU session or a certain UE or a certain QoS flow, the SN has allocated SN resources successfully, and SN may decide to change the PDU set based handling support status, e.g. when the SN is overloaded or the SN resources become available. When the SN decides to change the PDU set based handling support status, the SN may send at least one PDU set based handling indicator for the certain PDU session or for the certain UE or for the certain QoS flow to the MN via a message (Xn interface message, e.g. a SN modification required message, a SN change required message, or any other message).

For example, changing the PDU set based handling support status means that the SN that supported PDU set based handling decides to change to not support PDU set based handling, or the SN that didn't support PDU set based handling decides to change to support PDU set based handling.

Similar to the PDU set based handling indicator in step 520, the inclusion or non-inclusion of the PDU set based handling indicator may be used to notify the MN whether the SN supports the PDU set based handling for a certain PDU session or for a certain UE or for a certain QoS flow; and/or different values of the PDU set based handling indicator may be used to indicate whether the SN supports the PDU set based handling for a certain PDU session or for a certain UE or for a certain QoS flow.

For step 720, the MN may respond with a message (Xn interface message, e.g. a SN modification confirm message, a SN change confirm message, or any other message).

For step 730, the MN decides whether to send at least one PDU set based handling indicator or at least one pair of PDU set based handling indicator for the certain PDU session or for the certain UE or for the certain QoS flow to the CN based on whether the PDU set based handling support status changes at the MN and/or the SN.

For example, for a split PDU session, the MN may make the decision based on the principle in step 640 of Embodiments Sets II and III.

For example, when the MN does not allocate MN resources or the MN allocates MN resources for the certain PDU session or for the certain UE or for the certain QoS flow, the MN may make the decision based on the principle in step 640 of Embodiment set IV.

For example, the MN may make the decision based on the principle in step 640 of Embodiments Sets I, II and III.

For step 740, when the MN decides to send at least one PDU set based handling indicator or at least one pair of PDU set based handling indicator for the certain PDU session or for the certain UE or for the certain QoS flow to the CN based on the decision made in step 730, the MN sends at least one PDU set based handling indicator or at least one pair of PDU set based handling indicator for the certain PDU session or for the certain UE or for the certain QoS flow to the CN via a message (NG interface message, e.g. a PDU session resource modify indication message, a PDU session resource notify message, or any other message).

In some implementations with the PDU set based handling indicator, similar to the PDU set based handling indicator in step 520, the inclusion or non-inclusion of the PDU set based handling indicator may be used to notify the CN whether the RAN supports the PDU set based handling for a certain PDU session or for a certain UE or for a certain QoS flow; and/or different values of the PDU set based handling indicator may be used to indicate whether the RAN supports the PDU set based handling for a certain PDU session or for a certain UE or for a certain QoS flow.

In some implementations with the at least one pair of PDU set based handling indicator, similar to the PDU set based handling indicator in step 520, the inclusion or non-inclusion of the pair of PDU set based handling indicator may be used to notify the CN whether the MN and/or SN supports the PDU set based handling for a certain PDU session or for a certain UE or for a certain QoS flow; and/or different values of the pair of PDU set based handling indicator may be used to indicate whether the MN and/or SN supports the PDU set based handling for a certain PDU session or for a certain UE or for a certain QoS flow.

Based on the at least one PDU set based handling indicator or the at least one pair of PDU set based handling indicator, the CN may activate or deactivate the PDU set identification and marking.

For step 750, the CN may respond with a message (NG interface message, e.g. a PDU session resource modify confirm message, or any other message).

The present disclosure describes methods, apparatus, and computer-readable medium for wireless communication. The present disclosure addressed the issues with supporting PDU set based handling in DC. The methods, devices, and computer-readable medium described in the present disclosure may facilitate the performance of wireless communication by achieving flexible activation and deactivation of PDU set identification and marking, thus improving efficiency and overall performance. The methods, devices, and computer-readable medium described in the present disclosure may improves the overall efficiency of the wireless communication systems.

In some other embodiments, a computer-readable medium comprising instructions which, when executed by a computer, cause the computer to carry out the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
receiving, by a first network node from a second network node, a first message comprising a second indicator, wherein the second indicator indicates whether the second network node supports a protocol data unit (PDU) set based handling; and
determining, by the first network node, a first indicator set for sending to a core network (CN) based on supportability for PDU set based handling by at least one of two network nodes, wherein the two network nodes comprise the first network node and the second network node.

2. (canceled)

3. The method according to claim 1, wherein:
the first network node comprises a master node (MN) configured in a dual connectivity (DC), and the second network node comprises a secondary node (SN) in the DC.

4. (canceled)

5. The method according to claim 1, further comprising:
receiving, by the first network node, second message from the CN the second message comprising at least one set of PDU set parameters for at least one quality-of-service (QoS) flow; and
sending, by the first network node, a third message to the second network node, the third message comprising the at least one set of PDU set parameters for the at least one QoS flow.

6. The method according to claim 1, further comprising:
sending, by the first network node, a fourth message to the CN, the fourth message comprising the first indicator set.

7. The method according to claim 6, wherein:
the fourth message comprises a second NG interface message comprising one of the following: a PDU session resource setup response message, or a PDU session resource modify response message.

8. The method according to claim 1, wherein:
the first indicator set comprises a single first indicator; and
the first indicator indicates whether a radio access network (RAN) supports PDU set based handling.

9. The method according to claim 8, wherein, when a PDU session is a split PDU session, the determining the first indicator set comprises:
in response to at least one of the first network node and the second network node not supporting the PDU set based handling, determining the single first indicator as not support, or in response to both of the first network node and the second network node supporting the PDU set based handling, determining the single first indicator as support.

10-25. (canceled)

26. The method according to claim 5, wherein:
the first message comprises a first Xn interface message comprising one of the following: a SN addition request acknowledge message, or a SN modification request acknowledge message;
the second message comprises a first NG interface message comprising one of the following: a PDU session resource setup request message, or a PDU session resource modify request message; or
the third message comprises a second Xn interface message comprising one of the following: a SN addition request message, or a SN modification request message.

27. A first network node comprising:
a memory storing instructions; and
at least one processor in communication with the memory, wherein, when the at least one processor executes the instructions, the at least one processor is configured to cause the first network node to perform:
receiving, from a second network node, a first message comprising a second indicator, wherein the second indicator indicates whether the second network node supports a protocol data unit (PDU) set based handling; and
determining a first indicator set for sending to a core network (CN) based on supportability for PDU set based handling by at least one of two network nodes, wherein the two network nodes comprise the first network node and the second network node.

28. The first network node according to claim 27, wherein:
the first network node comprises a master node (MN) configured in a dual connectivity (DC), and the second network node comprises a secondary node (SN) in the DC.

29. The first network node according to claim 27, wherein, when the at least one processor executes the instructions, the at least one processor is configured to further cause the first network node to perform:
receiving a second message from the CN, the second message comprising at least one set of PDU set parameters for at least one quality-of-service (QoS) flow; and
sending a third message to the second network node, the third message comprising the at least one set of PDU set parameters for the at least one QoS flow.

30. The first network node according to claim 29, wherein:
the first message comprises a first Xn interface message comprising one of the following: a SN addition request acknowledge message, or a SN modification request acknowledge message;
the second message comprises a first NG interface message comprising one of the following: a PDU session resource setup request message, or a PDU session resource modify request message; or
the third message comprises a second Xn interface message comprising one of the following: a SN addition request message, or a SN modification request message.

31. The first network node according to claim 27, wherein, when the at least one processor executes the instructions, the at least one processor is configured to further cause the first network node to perform:
sending a fourth message to the CN, the fourth message comprising the first indicator set.

32. The first network node according to claim 31, wherein:
the fourth message comprises a second NG interface message comprising one of the following: a PDU session resource setup response message, or a PDU session resource modify response message.

33. The first network node according to claim 27, wherein:
the first indicator set comprises a single first indicator; and
the first indicator indicates whether a radio access network (RAN) supports PDU set based handling.

34. The first network node according to claim 33, wherein, when a PDU session is a split PDU session, the determining the first indicator set comprises:
in response to at least one of the first network node and the second network node not supporting the PDU set based handling, determining the single first indicator as not support, or
in response to both of the first network node and the second network node supporting the PDU set based handling, determining the single first indicator as support.

35. A non-transitory computer-readable medium storing instructions, wherein, the instructions, when executed by a first network node, are configured to cause the first network node to perform:
receiving, from a second network node, a first message comprising a second indicator, wherein the second indicator indicates whether the second network node supports a protocol data unit (PDU) set based handling; and
determining a first indicator set for sending to a core network (CN) based on supportability for PDU set based handling by at least one of two network nodes, wherein the two network nodes comprise the first network node and the second network node.

36. The non-transitory computer-readable medium according to claim 35, wherein:
the first network node comprises a master node (MN) configured in a dual connectivity (DC), and the second network node comprises a secondary node (SN) in the DC.

37. The non-transitory computer-readable medium according to claim 35, wherein the instructions, when executed by the first network node, are configured to further cause the first network node to perform:
receiving a second message from the CN, the second message comprising at least one set of PDU set parameters for at least one quality-of-service (QoS) flow; and
sending a third message to the second network node, the third message comprising the at least one set of PDU set parameters for the at least one QoS flow.

38. The non-transitory computer-readable medium according to claim 35, wherein the instructions, when executed by the first network node, are configured to further cause the first network node to perform:
sending a fourth message to the CN, the fourth message comprising the first indicator set.
